(19) United States
(12) Patent Application Publication
(10) Pub. No.: US 2025/0326180 A1
(43) Pub. Date: Oct. 23, 2025

(54) TRANSPARENT DISPLAY MODULE FOR STEREOLITHOGRAPHY APPARATUS

(71) Applicant: SprintRay, Inc., Los Angeles, CA (US)

(72) Inventor: Shukun Ye, Los Angeles, CA (US)

(21) Appl. No.: 19/185,233

(22) Filed: Apr. 21, 2025

Related U.S. Application Data
(60) Provisional application No. 63/636,767, filed on Apr. 20, 2024.

(51) Int. Cl. B29C 64/264; B29C 64/129; B33Y 30/00; G02F 1/1333; G02F 1/1335

(52) U.S. Cl. CPC B29C 64/264; B29C 64/129; B33Y 30/00; G02F 1/133308; G02F 1/133526; G02F 1/133528

(57) ABSTRACT

A display cartridge system for use with a three-dimensional printing apparatus is disclosed. The display module of the system includes an LCD panel with two NUV polarizers and a liquid crystal layer. The utilization of the transparent LCD panel increases the transmittance ratio and decreases light attenuation, thereby improving the efficiency of the curing process and lifespan of the system. The transparent LCD panel with NUV polarizers are replaceable or removable, and may be integrated with a stereolithography system to enhance the efficiency of the light-curing process, reduce thermal stress on components of the system, and extend the lifespan of said system.

### PRIORITY AND RELATED APPLICATIONS

This application is a U.S. nonprovisional application which claims priority to U.S. Provisional Application No. 63/636,767 filed on Apr. 20, 2024, the disclosure of which are incorporated by reference in their entirety.

### TECHNICAL FIELD

The present invention generally relates to the field of three-dimensional printing systems. More specifically, the present invention relates to a removable display cartridge system for use with a stereolithography (SLA) system.

### BACKGROUND

Three-dimensional (3D) printing technology enables the creation of objects by causing portions of a building material to solidify at specific locations based on a digital model. In 3D printing, objects are built one layer at a time. Each layer corresponds to a cross-sectional slice of the final product, based on digital 3D model data. The printer deposits or cures the building material in precise locations as defined by the 3D model and solidifies the material layer by layer until the object is fully formed. This method allows for a highly controlled and precise fabrication process. However, this level of control is not typically possible with conventional manufacturing methods such as casting or machining.

Stereolithography is a form of 3D printing technology that utilizes a light engine, typically a laser or a digital light projector, to cure photosensitive polymers layer by layer to form solid 3D objects from a liquid resin. However, traditional SLA systems face limitations such as inefficient light usage, significant thermal dissipation issues, and a relatively high rate of component wear and tear, which could reduce the operational lifespan of the stereolithography system.

Further, existing systems commonly use either opaque or semi-transparent LCDs or other forms of static masks, which impedes the efficiency of light transmission, thereby requiring higher energy consumption and increasing heat output. Furthermore, the decline in transmittance ratio reduces the efficiency of the curing process and also accelerates the degradation of critical system components, which leads to increased maintenance costs and downtime of the system.

In addition, LCD panels have a limited lifespan, and because they are somewhat fragile, they may be damaged (e.g., cracked) during use. When this happens, the LCD panels require replacement and/or maintenance.

However, conventional procedures to remove and subsequently replace LCD panels within current 3D printing systems are currently quite laborious. Such procedures often include over ten specific steps that may require one or more hours to complete. In addition, current systems require highly skilled personnel to perform the maintenance. For example, such systems require optical masking tape to be precisely applied at the perimeter of the LCD panels.

Accordingly, there is a need for a replaceable or removable LCD screen cartridge system for 3D printers or additive manufacturing systems. Also, there is a need for a replaceable LCD screen cartridge system to provide an easy removal method to simplify the screen replacement process. Further, there is a need for a replaceable LCD screen cartridge system that provides an easy screen replacement without the need for extensive training or assembly experience.

Moreover, there is a need for a stereolithography (SLA) system that enhances the efficiency of the light-curing process, reduces thermal stress on components of the system, and extends the lifespan of the system.

It is to these ends that the present invention has been developed.

### SUMMARY OF THE INVENTION

According to the present invention, a system and device is described for a display cartridge system for use with a stereolithography (SLA) system.

In some exemplary embodiments, a display cartridge system for use with a three-dimensional (3D) printer for printing a 3D-object, is comprised of: a display module including a display panel and a light engine, wherein the display module is configured to be removably coupled to a material tank of the 3D-printer; and a support structure housing the display module, wherein the support structure is configured to be removably coupled to a base of the 3D-printer. In some exemplary embodiments, the display module is adapted to be removable and or replaceable.

The display module may include a liquid crystal layer, a first polarizer, a second polarizer, a glass layer, and at least one lens. The first and second polarizers of the display cartridge system may be disposed on opposite ends of the display panel. In some exemplary embodiments, the first and second polarizers may be near- ultraviolet (NUV) polarizers. In some exemplary embodiments, the first polarizer may be an organic polarizer configured to filter a light from the light engine. In some exemplary embodiments, the second polarizer may be an inorganic polarizer configured to adjust an intensity of a light from the light engine. In some exemplary embodiments, the liquid crystal layer may be configured to selectively modulate a light from the light engine.

In some exemplary embodiments, the at least one lens is coupled to the light engine and is configured to focus and direct a light from the light engine. In some exemplary embodiments, the first and second polarizers may be configured to allow a passage of light from the light engine when in a parallel state. In some exemplary embodiments, the first and second polarizers may be configured to block a passage of light from the light engine when in a crossed state. In some exemplary embodiments, the display panel may be transparent. In some exemplary embodiments, the display panel may be a transparent LCD display panel.

In some exemplary embodiments, the support structure may be a cradle assembly. In some exemplary embodiments, the support structure is further configured to support and to be removably coupled to the display panel. In some exemplary embodiments, the support structure may be further configured to removably coupled to a base of the 3D-printer in accordance with the present invention. In some exemplary embodiments, the display panel may be positioned below the material tank of a 3D-printer and above the light engine of the display module. In some exemplary embodiments, the light engine and the display panel may be in communication with a printing control system of the 3D printer, wherein the printing control system may be configured to control a light emitted by the light engine to a printing platform through the display panel and thereby selectively polymerize a layer of the print material. In some exemplary embodiments, the display panel may be configured to increase a transmittance ratio of a light from the light engine.

In some exemplary embodiments, the present invention discloses a transparent Liquid Crystal Display (LCD) panel for use in a stereolithography (SLA) system., wherein the LCD the panel may include a first polarizer and a second polarizer, the second polarizer is disposed opposite to the first polarizer and a liquid crystal layer disposed between the first polarizer and the second polarizer. In some exemplary embodiments, the first polarizer may be an inorganic polarizer and the second polarizer may be an organic polarizer. In some exemplary embodiments, the display panel may further include a lid disposed adjacent to the second polarizer and a glass layer disposed adjacent to the first polarizer. In some exemplary embodiments, the display panel further includes at least one lens disposed adjacent to the glass layer. In some exemplary embodiments, the display panel maybe in communication with the light engine of the system.

In yet another exemplary embodiment, an exemplary stereolithography system may comprise a rack, the light engine, a raw material tank, a printing platform, a lifting device, a printing control system, and the display cartridge system described in any one of the embodiments of the present disclosure. The lifting device may be configured to be coupled to the printing platform and may be disposed on the rack. The raw material tank may be disposed below the printing platform, the display module disposed below the raw material tank, and the light engine disposed below the display module. In some exemplary embodiments, the display module includes a LCD display panel.

In some exemplary embodiments, the printing control system may be electrically connected to the light engine, the lifting device, and the display module, and may be configured to control a light emitted by the light engine of the display module to be emitted to the printing platform through the display panel of the display module to enable raw material on a surface of the printing platform to implement 3D printing. In some exemplary embodiments, the display panel is a transparent LCD display panel wherein integration of said panel improves efficiency, reduces thermal dissipation and prolongs lifespan of the LCD panel and an exemplary stereolithography system.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

### BRIEF DESCRIPTION OF DRAWINGS

Elements in the figures have not necessarily been drawn to scale in order to enhance their clarity and improve understanding of these various elements and embodiments of the present invention. Furthermore, elements that are known to be common and well understood to those in the industry are not depicted in order to provide a clear view of the various embodiments of the invention.

FIG. 1A-FIG. 1B illustrate block diagrams of replaceable visual display modules in accordance with some exemplary embodiments of the present invention.

FIG. 1C exemplarily illustrates an exploded view of the display panel of a display cartridge system in accordance with an exemplary embodiment of the present invention.

FIG. 2A-FIG. 2B exemplarily illustrate perspective views of the display panel of the display cartridge system in accordance with an exemplary embodiment of the present invention.

FIG. 3 illustrates a perspective view of an LCD panel of a display cartridge system for use with a stereolithography system in accordance with exemplary embodiments of the present invention.

FIG. 4 exemplarily illustrates masked stereolithography system, according to an exemplary embodiment of the present invention.

FIG. 5 exemplarily illustrates schematic of function of a polarizer of the display panel in accordance with an exemplary embodiment of the present invention.

FIG. 6 is a graph showing a comparison of the transmittance ratio of a polarizer in accordance with an exemplary embodiment of the present invention and a conventional polarizer.

FIG. 7 is a graph showing a comparison of parallel transmittance of NUV (Near-ultraviolet) polarizer in accordance with an embodiment of the present invention and a conventional polarizer.

FIG. 8 is a graph showing a comparison of the contrast ratio of NUV (Near-ultraviolet) polarizer in accordance with the present invention and a conventional polarizer.

### DETAILED DESCRIPTION

Referring now to the present subject matter in more detail, a display cartridge system for use with a three-dimensional (3D) printer for printing a 3D-object is described herein.

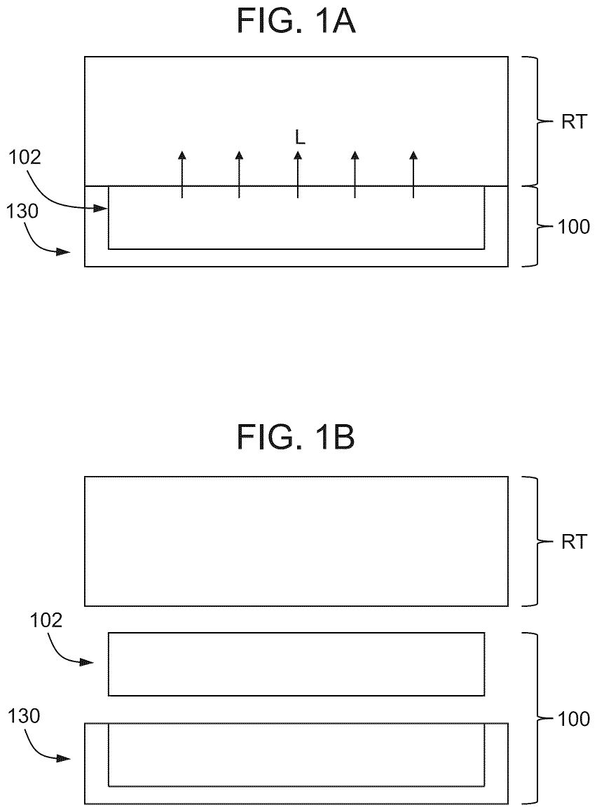

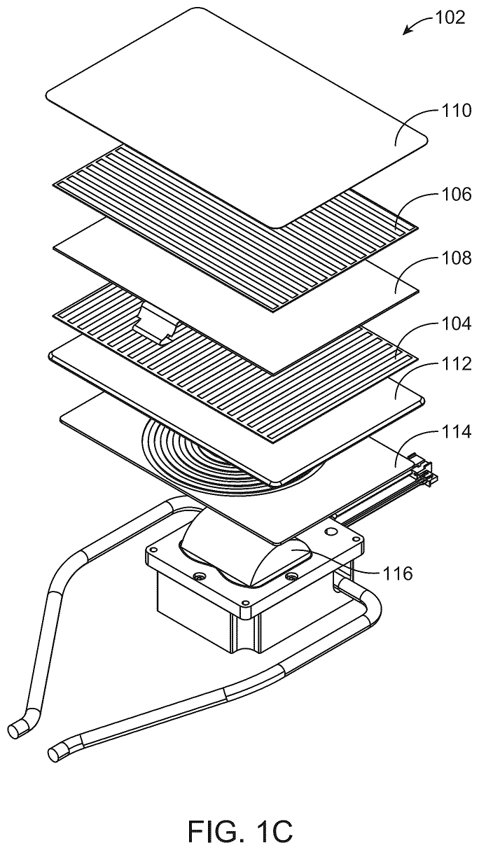

Turning now to the figures, FIG. 1A illustrates a block diagram of an exemplary display cartridge system for use with a three-dimensional printer. FIG. 1B illustrates an exploded view of a block diagram of an exemplary display cartridge system for use with a three-dimensional printer. More specifically, FIGS. 1A and 1B illustrates a block diagram of the display module 100 and a support structure 130 of an exemplary display cartridge system and the resin tank of a 3D-printer in accordance with the present invention. In some exemplary embodiments, the display cartridge system 100 is comprised of a display module 102 and a support structure 130, wherein the display module 102 may include a display panel and a light engine and may be configured to be removably coupled to a material or resin tank RT of a 3D-printer. In some exemplary embodiments, as illustrated in FIG. 1A, the support structure may be configured to house the display module 102, the support structure configured to be removably coupled to a base of a 3D-printer.

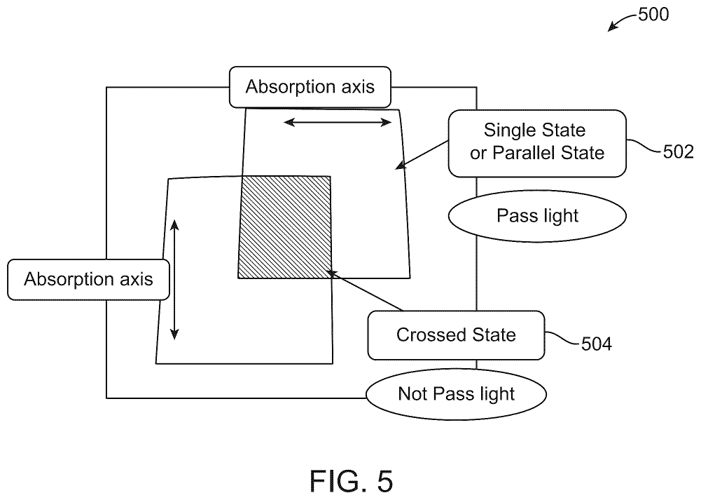

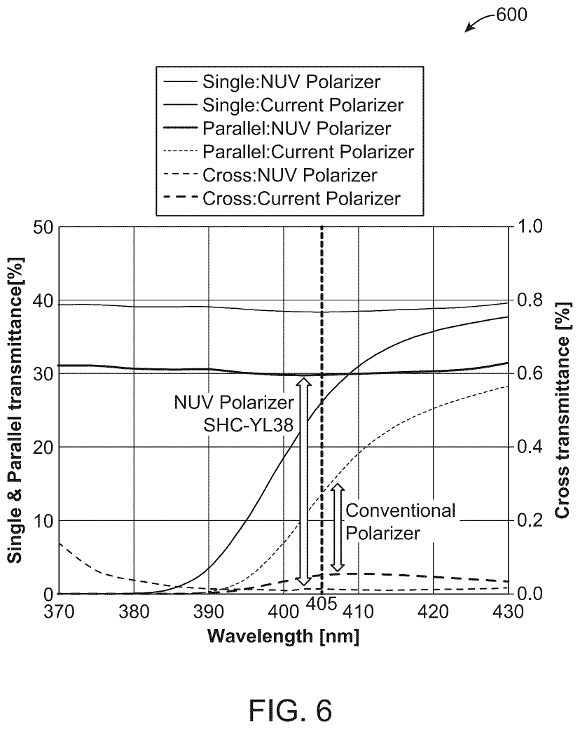

In some exemplary embodiments, the display panel of an exemplary display module 102 may include a liquid crystal layer, a first polarizer, a second polarizer, a glass layer, and at least one lens. In some exemplary embodiments, the first and second polarizers may be disposed on opposite ends of the display panel. In some exemplary embodiments, the first and the second polarizers may be near-ultraviolet (NUV) polarizers. In some exemplary embodiments, the display panel of a display cartridge system in accordance with the present invention may include a plurality of polarizers. In some exemplary embodiments, the display panel may include an organic polarizer configured to filter a light from the light engine and may also include a second polarizer configured to adjust an intensity of a light from the light engine. The liquid crystal layer of the display panel may be configured to selectively modulate a light from the light engine in some exemplary embodiments. In some exemplary embodiments, at least one of the lens of the display panel may be coupled to the light engine and may be configured to focus and direct the light from the light engine. As will be discussed further below, the first and second polarizers of the display panel may be configured to allow a passage of light from the light engine when in a parallel state and further configured to block a passage of light from the light engine when in a crossed state as illustrated in FIGS. 5, 6 In some exemplary embodiments, the display panel may be transparent. In some exemplary embodiments, the support structure 130 may be a cradle assembly. In some exemplary embodiments, the support structure 130 may be further configured to support and to be removably coupled to the display module 102. In some exemplary embodiments, the display panel may be positioned below the material or resin tank RT and above the light engine. In some exemplary embodiments, the display panel may be disposed between the material or resin tank RT and the light engine.

In some exemplary embodiments, the light engine and the display panel are in communication with a printing control system of a 3D printer in accordance with the present invention, wherein the printing control system may be configured to control a light emitted by the light engine to the printing platform through the display panel and thereby selectively polymerize a layer of the print material. In some exemplary embodiments, the display panel may be configured to increase a transmittance ratio of a light from the light engine.

In some exemplary embodiments, as illustrated by the block diagram in FIG. 1A, the display module 102 may be configured with or adapted to couple with a resin tank RT, e.g., for use with a three-dimensional printing system in accordance with the present invention.

In some exemplary embodiments, the display module or visual display module 102 is comprised of a display panel configured to produce a visual output for the user of a 3D-printer in accordance with the present invention. For example, and in no way limiting the scope of the present invention, the display panel may be a liquid crystal display (LCD) panel.

In some exemplary embodiments, the display module 102 may be removable and or replaceable. In some exemplary embodiments, the display module 102 may be removably coupled to a material or resin tank RT of a 3D-printer. In some exemplary embodiments, as illustrated in FIG. 1A, the display module 102 may be coupled to the bottom of the material or resin tank RT of a 3D-printer. In some exemplary embodiments, the light engine of the display module 102 may be configured to emit a resin-curing light L upward and into the resin tank RT for three-dimensional printing purposes.

In some exemplary embodiments, as illustrated in FIG. 1A, the display cartridge system 100 may be comprised of a display assembly or panel and a support structure or a cradle assembly 130, wherein the display panel may be transparent and the cradle assembly 130 may be configured to support the display panel. In some exemplary embodiments, the cradle assembly 130 may be further configured to be removably mounted to a base of a three-dimensional printer.

In some exemplary embodiments, as illustrated in FIG. 1B, the display cartridge system 100 may be removed from the resin tank RT, and the display panel or display module 102 may be removed from the cradle assembly 130 for replacement, maintenance, etc. Subsequently, a new and or refurbished display panel or display module, for example, may be installed into the support structure or cradle assembly 130 and the resulting reconfigured display cartridge system 100 may be coupled to the resin tank RT for further use.

In some exemplary embodiments, the display cartridge system 100 include a display cartridge and a cradle assembly, the display cartridge may be comprised of a transparent liquid crystal display (LCD) panel that is removable and or replaceable and may be configured to serve as the illumination source for an exemplary display cartridge system. In some exemplary embodiments, the display module may be an LCD screen cartridge that includes an illumination panel or an LCD display panel. However, in other exemplary embodiments, the display module 100 of a display cartridge system may include any type of suitable illumination device(s) known to those of ordinary skill in the art, and the scope of the display module 100 is not limited in any way by the type of illumination device(s) that it may utilize.

Referring to FIG. 1C to FIG. 3, the display cartridge system may be comprised of a display module and a support structure, wherein the display module 100 includes display panel 102 and a light engine. In some exemplary embodiments, the display panel may be a Liquid Crystal Display panel (LCD), wherein the LCD panel 102 is configured to increase the passage or transmittance of UV light from a light engine 116 for curing the resin. As the result, the display cartridge system may reduce energy consumption, and increase the speed of the curing process of a stereolithography system. Thus, the higher transmittance ratio of the LCD panel 102 may increase the speed of the 3D-printing process in an energy efficient manner. Accordingly, the utilization of an LCD panel 102 may provide higher transmittance ratio and enhances longevity of the system 100.

As illustrated in FIG. 1C, the display panel or display module 102 may be comprised of at least two polarizers 104, 106 disposed on opposite ends. In some exemplary embodiments, the at least two polarizers may include a first polarizer 104 and a second polarizer 106. In some exemplary embodiments, at least one polarizer 104 is an inorganic polarizer and at least another polarizer 106 is an organic polarizer. In some exemplary embodiments, the polarizers 104, 106 may be comprised of a material with high durability and optical performance. For example, and in no way limiting the scope of the present invention, the inorganic polarizer of a display panel 102 may be a metal grid polarizer.

In some exemplary embodiments, the second polarizer 106 may be disposed opposite to the first polarizer 104. In some exemplary embodiments, the display panel 102 may further include a liquid crystal layer 108 disposed between the first polarizer 104 and the second polarizer 106. The first polarizer 104 may be configured to filter light from the light engine 116. In some exemplary embodiments, the first polarizer 104 may be configured to filter a UV light from the light engine and to allow light waves vibrating in a specific direction to pass through the first polarizer 104. The directional control of light of the first polarizer 104 ensures that the light used to cure the resin in the SLA process is uniformly polarized, thereby enhancing the precision of the curing process for a 3D-printer in accordance with the present invention. In some exemplary embodiments, the UV LED spectrum used in conjunction with the transparent LCD panel 102 may be 385 nm or some other suitable wavelength range that optimizes compatibility and performance.

Further, in some exemplary embodiments, the liquid crystals within the liquid crystal layer 108 may be oriented in such a manner that they may be electrically controlled to selectively modulate the UV light passing there through. The liquid crystal layer 108 acts as a dynamic mask that may be configured to rapidly change to form different layers of the 3D object to be printed.

In some exemplary embodiments, the second polarizer 106 may be configured to work in conjunction with the first polarizer 104 to adjust or fine-tune the light intensity and ensure that the light that passing through the display panel 102 is correctly aligned to precisely cure the resin.

In some exemplary embodiments, the display panel 102 may further comprise a lid 110 disposed adjacent to the second polarizer 106 and a glass layer 112 disposed adjacent to the first polarizer 104 as illustrated in FIG. 1C. The glass layer 112 of an exemplary display panel 102 may be configured to provide additional protection and structural support to the display panel 102. Furthermore, the glass layer 112 may also contribute to the overall aesthetic and durability of said display panel 102 in some exemplary embodiments in accordance with the present invention.

The display panel 102 further comprises at least one lens 114 disposed adjacent to the glass layer 112. The display panel 102 may be connected to the light engine 116 of the display module 100 of an exemplary cartridge display system. In some exemplary embodiments, the lens layer 114 is configured to efficiently focus and direct a light from the light engine. In some exemplary embodiments, the lens 114 may be a Fresnel lens.

In some exemplary embodiments, as illustrated in FIG. 1C, the display panel 102 further comprises a protective sheet or lid 110, the protective sheet or lid 110 configured to protect the underlying components of the display module 100 from external environmental factors or conditions that may result in physical damage, dust, and scratches.

In some exemplary embodiments, the display panel 102 may include a Optical Clear Adhesive (OCA) layer to bond one or more layers of the display panel 102, wherein the OCA layer may be configured to provide an adhesive connection between the layers while ensuring transparency and further ensuring that no air bubbles are present.

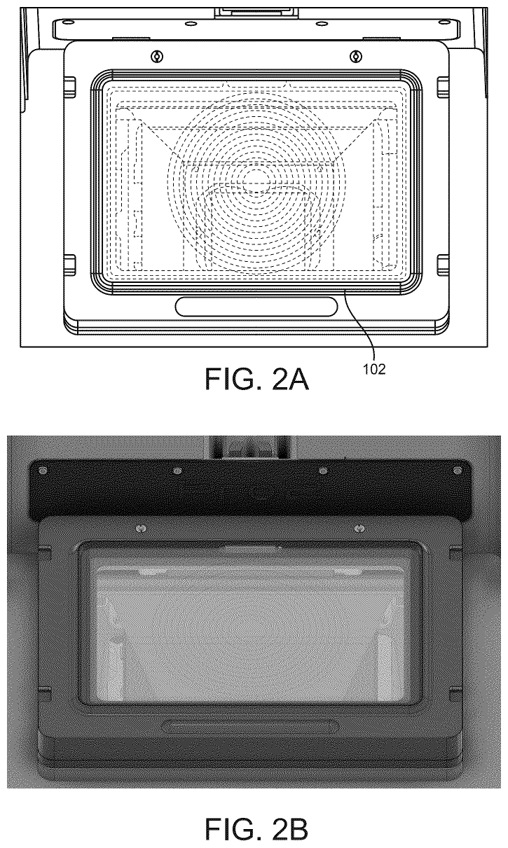

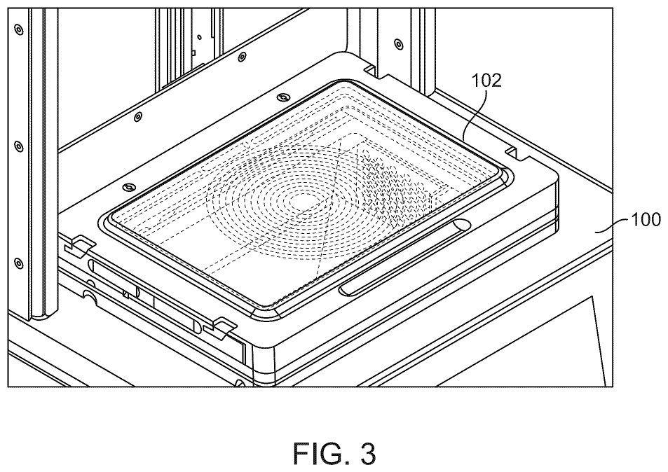

FIG. 2A-2B exemplarily illustrate perspective views of the display panel of a display cartridge system integrated with a 3D-printed in accordance with exemplary embodiments of the present invention. FIG. 3 illustrates a perspective view of a LCD panel of a display cartridge system for use with a stereolithography system in accordance with exemplary embodiments of the present invention.

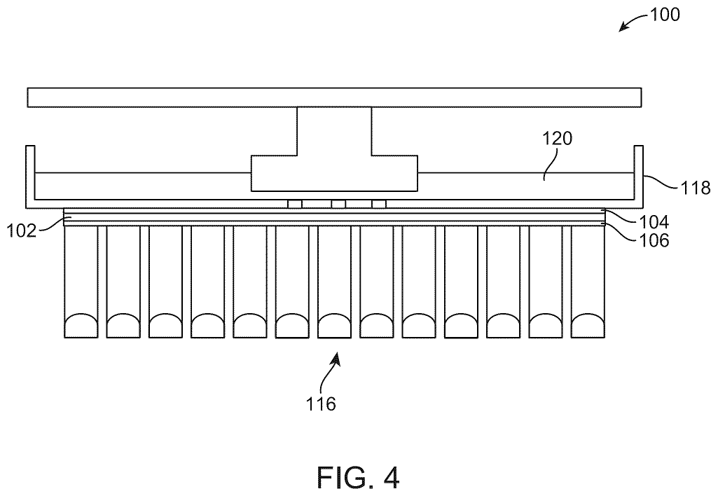

Turning now to the next figure, FIG. 4 illustrates an exemplary stereolithography system 100 integrated with a display cartridge system in accordance with the present invention. The SLA system 100 enables selective exposure to light masked by the display panel 102. In some exemplary embodiments, the SLA system 100 comprises a rack, a light engine 116, a raw material tank 118, a printing platform, a lifting device, a printing control system, and a display panel 102. In yet another exemplary embodiment, the display cartridge system integrated with the SLA system includes a first and polarizer 104, 106, a light engine 116, and a display panel 102, wherein the display panel 102 may be a transparent LCD panel. The display cartridge system is adapted to be removably coupled to the SLA system 100 to facilitate easy access for a user for purposes of replacement, repair, maintenance, etc. In some exemplary embodiments, the lifting device may be connected to the printing platform and may be disposed on the rack. In some exemplary embodiments, the raw material or resin tank may be disposed below the printing platform, the display panel 102 may be disposed below the raw material or resin tank, and the light engine 116 may be disposed below the liquid crystal display panel 102. In some exemplary embodiments, the light engine 116 is configured to emit a UV light.

In some exemplary embodiments, the printing control system may be in electrically connected to the light engine 116, the lifting device, and the liquid crystal display panel 102, and may be configured to control a light emitted by the light engine 116 to be emitted to the printing platform through the display panel 102, thereby enabling a raw material 120 on a surface of the printing platform to implement 3D printing. In some exemplary embodiments, the raw material 120 may be a UV curable resin to be cured by the UV light emitted from the light engine.

In some exemplary embodiments, the display panel of an exemplary display cartridge system in accordance with the present invention may include polarizers (104, 106) that are NUV (Near-ultraviolet) polarizers. For example, and in no way limiting the scope of the present invention, the NUV (Near-ultraviolet) polarizer may be a Dye-type film polarizer that uses high performance dyes, and has excellent optical performance around 405 nm. In some exemplary embodiments, the NUV polarizers 104, 106 of an exemplary display panel 102 may have a structure that comprises: protective film, TAC, PVA (Polyvinyl alcohol), TAC, adhesive, and release film, wherein the TAC and PVA defines an effective part of 215 μm.

Turning now to the next figure, FIG. 5 exemplarily illustrates a schematic 500 of a function of the polarizers 104, 106 of an exemplary display panel in accordance with an embodiment of the present invention. As illustrated by the schematic in FIG. 5, the single state or parallel state 502, the first and second polarizers 104, 106 may be configured to allow light to pass through when in a single state or when in a parallel state. As further illustrated by the schematic in FIG. 5, the polarizers 104, 106 may be configured to block the passage of light when in a crossed state 504. The schematic 500 further illustrates an exemplary absorption axis of the polarizers 104, 106 of an exemplary LCD display panel in accordance with the present invention.

Turning now to the next figure, FIG. 6 illustrates a graph showing the optical performance of the polarizers in accordance with an exemplary embodiment of the present invention. More specifically, FIG. 6illustrates a graph that compares the optical performance of exemplary polarizers in accordance with the present invention in comparison to conventional polarizers. For example, and in no way limiting the scope of the present invention, at 405 nm, the optical performance of an exemplary NUV polarizer shows: 39.10% of single transmittance, 30.58% of Transmittance in Parallel state, 0.0004% of Transmittance in Crossed state, 99.997% of Polarizing efficiency and 76,440 of Contrast ratio. In comparison, the optical performance of conventional polarizer at 405 nm shows: 25.89% of single transmittance, 13.35% of Transmittance in Parallel state, 0.0511% of Transmittance in Crossed state, 99.238% of Polarizing efficiency and 261 of Contrast ratio. The high transmittance of the exemplary NUV polarizer achieves low illumination thereby saving power and shortens the length of the curing time for 3D printers by allowing for higher throughput in comparison to the optical performance of conventional polarizers. Furthermore, the high contrast ratio of the NUV polarizers in accordance with exemplary embodiments of the present invention achieves high precision in 3D printers.

In yet another example, and in no way limiting the scope of the present invention, the optical performance of NUV polarizer at 385 nm shows: 39.16% of single transmittance, 30.64% of Transmittance in Parallel state, 0.019% of Transmittance in Crossed state, 99.94% of Polarizing efficiency and 1,613 of Contrast ratio. In comparison, the optical performance of conventional polarizer At 385 nm shows: 0.43% of single transmittance, 0.02% of Transmittance in Parallel state, 0.001% of Transmittance in Crossed state, 95.12% of Polarizing efficiency and 20 of Contrast ratio. Conventional polarizers don't have a high contrast at 385 nm because of low transmittance. Accordingly, as illustrated by FIG. 6, the NUV polarizers of a display cartridge system in accordance with the present invention has high transmittance, high polarizing efficiency and high contrast ratios in comparison to their conventional counterparts at lower wavelengths including but not limited to 385 nm.

In some exemplary embodiments, the display panel 102 may be a transparent display panel that includes at least two NUV polarizers, wherein the NUV polarizers are configured to provide a higher transmittance ratio and light utilization efficiency in comparison to their conventional counterparts. The higher transmittance ratio minimizes heat generation within the display cartridge system and thereby reduces the thermal stress on the components of a display panel 102 and increases the lifespan of said panel 102 by decreasing wear and tear over time.

In some exemplary embodiments, the LCD display panel 102 may also be configured to reduce thermal dissipation. The LCD panel 102 may be configured to allow the passage of more light with less absorption, generating less heat. However, the traditional LCDs absorb more light and generate more heat, and require additional mechanisms to manage the heat, such as cooling systems or heat sinks. The reduction of generation of heat by the present invention lowers the strain on thermal management system of the SLA system 100. Accordingly, the integration of an LCD panel 102 may eliminate the need for additional components to manage heat and simplifies the design of the system 100.

This reduced thermal stress increases operational lifespan for the LCD panels 102 and potentially other nearby components within the system 100. With lower heat generation, the system 100 reduces the risk of overheating and the associated malfunctions, and enhances the reliability and durability of the system 100. In some exemplary embodiments, the LCD panel 102 of an exemplary display cartridge system in accordance with the present invention may be integrated with a three-dimensional printing apparatus.

In some exemplary embodiments, the display panel 102 of a display cartridge system 100 may be configured to reduce the risk of overheating and associated malfunctions, thereby extending the operational lifespan of said panel 102. The durability and efficiency of the display cartridge system 100 reduces maintenance requirement and downtime, and enhances reliability of the 3D printing process.

Turning now to the next figure, FIG. 6 illustrates a graph 600 showing the polarizing efficiency of polarizers of a display cartridge system in accordance with exemplary embodiments of the present invention. More specifically, FIG. 6 illustrates the transmittance ratio as a percentage in relationship to the wavelength of polarizers in their single state, parallel state, and cross state. For example, and in no way limiting the scope of the present invention, the optical feature of the NUV polarizer exhibits: Single Transmittance at 405 nm (Ts@405) of 38±20%, and a Polarizing efficiency at 405 nm (PE@405)≥99.9%. In yet another example, and in no way limiting the scope of the present invention, the durability feature of the NUV polarizer exhibits: Heat resistance 105° C.×500 h, and Humidity resistance 60° C.90%×1000 h.

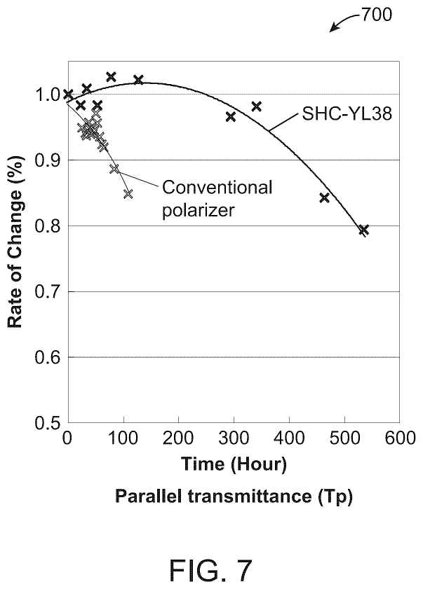

Turning now to the next figure, FIG. 7 illustrates a graph 700 showing the parallel transmittance and rate of change for polarizers in accordance with exemplary embodiments of the present invention. More specifically, FIG. 7 illustrates a graph comparing the parallel transmittance of exemplary NUV (Near-ultraviolet) polarizers and conventional polarizers, according to an exemplary embodiment of the present invention.

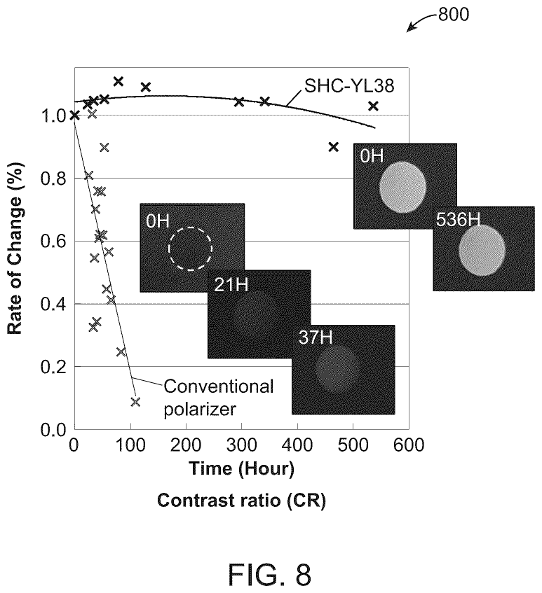

Turning now to the next figure, FIG. 8 illustrates a graph 800 showing the relationship between the rate of change and contrast ratio over time. More specifically, FIG. 8 illustrates a comparison of the contrast ratio of NUV (Near-ultraviolet) polarizers in accordance with an exemplary embodiment of the present invention and conventional polarizers.

As illustrated by FIG. 8, the lifespan of NUV polarizers in accordance with exemplary embodiments of the present invention significantly outlast those of conventional polarizers, as demonstrated by light fastness testing through exposure of LED at a wavelength of 405 nm. In some exemplary embodiments, an exemplary NUV polarizer may not demonstrate any change or degradation in color after 536 hours (536 H) of exposure whereas a conventional polarizer shows an immediate change in colors as illustrated in the graph 800. In some exemplary embodiments, the display panels 102 may be transparent LCD panels that feature a higher transmittance ratio compared to traditional LCD screens as illustrated in FIG. 6 Accordingly, such exemplary transparent LCD panels 102 may be configured to allow more UV LED light to pass through and thereby enhance the efficiency of an exemplary SLA system 100 in accordance with the present invention. Furthermore, the increased transmittance ratio may also decrease light attenuation within the system 100. In some exemplary embodiments, the two polarizers 104, 106 are configured to maximize the effectiveness of the UC curing process through their implementation of the display panel 102 by ensuring optimal light transmission from the light of the light engine.

As further illustrated by FIG. 8, a NUV polarizer in accordance with exemplary embodiments of the present invention has a significantly longer lifespan in comparison to conventional polarizers. Accordingly, the integration of a transparent LCD display panel 102 with NUV polarizers contributes to the prolonged lifespan of the display module of a display cartridge system 100 for use with a 3D printer.

The embodiments described herein are not intended to be exhaustive or to limit the present subject matter to the precise forms disclosed. Rather, the embodiments selected for description have been chosen to enable one skilled in the art to practice the present subject matter. It should be understood that various modifications, adaptations, and alternatives may be employed without departing from the spirit and scope of the present subject matter.

The foregoing description comprises illustrative embodiments of the present subject matter. Having thus described exemplary embodiments of the present subject matter, it should be noted by those skilled in the art that the within disclosures are exemplary only, and that various other alternatives, adaptations, and modifications may be made within the scope of the present subject matter. Merely listing or numbering the steps of a method in a certain order does not constitute any limitation on the order of the steps of that method. M any modifications and other embodiments of the present subject matter will come to mind to one skilled in the art to which this present subject matter pertains having the benefit of the teachings in the foregoing descriptions. Although specific terms may be employed herein, they are used only in generic and descriptive sense and not for purposes of limitation. Accordingly, the present subject matter is not limited to the specific embodiments illustrated herein.

What is claimed is:

1. A display cartridge system for use with a three-dimensional (3D) printer for printing a 3D-object, comprising:
a display module including a display panel and a light engine, the display module configured to be removably coupled to a material tank of the 3D-printer; and
a support structure housing the display module, the support structure configured to be removably coupled to a base of the 3D-printer.

2. The display cartridge system of claim 1, wherein the display panel includes a liquid crystal layer, a first polarizer, a second polarizer, a glass layer, and at least one lens.

3. The display cartridge system of claim 2, wherein the first and second polarizers are disposed on opposite ends of the display panel.

4. The display cartridge system of claim 2, wherein the first and second polarizers are near-ultraviolet (NUV) polarizers.

5. The display cartridge system of claim 2, wherein the first polarizer is an organic polarizer configured to filter a light from the light engine.

6. The display cartridge system of claim 2, wherein the second polarizer is an inorganic polarizer configured to adjust an intensity of a light from the light engine.

7. The display cartridge system of claim 2, wherein the liquid crystal layer is configured to selectively modulate a light from the light engine.

8. The display cartridge system of claim 2, wherein the at least one lens is coupled to the light engine and is configured to focus and direct a light from the light engine.

9. The display cartridge system of claim 2, wherein the first and second polarizers are configured to allow a passage of light from the light engine when in a parallel state.

10. The display cartridge system of claim 2, wherein the first and second polarizers are configured to block a passage of light from the light engine when in a crossed state.

11. The display cartridge system of claim 1, wherein the display panel is transparent.

12. The display cartridge system of claim 1, wherein the support structure is a cradle assembly.

13. The display cartridge system of claim 1, wherein the support structure is further configured to support and to be removably coupled to the display panel.

14. The display cartridge system of claim 1, wherein the display panel is positioned below the material tank and above the light engine.

15. The display cartridge system of claim 1, wherein the light engine and the display panel are in communication with a printing control system of the 3D printer, the printing control system configured to control a light emitted by the light engine to a printing platform through the display panel and thereby selectively polymerize a layer of the print material.

16. The display cartridge system of claim 1, wherein the display panel is configured to increase a transmittance ratio of a light from the light engine.

17. A display cartridge system for use with a three-dimensional (3D) printer for printing a 3D-object, comprising:
a display module including an at least two polarizers, a liquid crystal layer, and a light engine, the display module configured to be removably coupled to a resin tank of the 3D printer; and
a cradle assembly housing the display module, the cradle assembly configured to be removably coupled to the display module at to a base of the 3D-printer.

18. The display cartridge system of claim 17, wherein the display module further includes at least one lens, a glass layer and a lid.

19. The display cartridge system of claim 17, wherein one of the at least two polarizers is an organic polarizer configured to filter a light from the light engine.

20. The display cartridge system of claim 19, wherein one of the at least two polarizers is an inorganic polarizer configured to adjust an intensity of a light from the light engine.

21. The display cartridge system of claim 19, wherein the organic and inorganic polarizers are near-ultraviolet (NUV) polarizers.

22. The display cartridge system of claim 19, wherein the organic and inorganic polarizers are positioned on opposite ends of the display module.
